(19) United States
(12) Patent Application Publication
(10) Pub. No.: US 2010/0314034 A1
(43) Pub. Date: Dec. 16, 2010

(54) LAMINATE FOR EYEGLASS FRAME WITH EMBEDDED DESIGN PATTERN AND MANUFACTURING METHOD THEREOF

(75) Inventor: Yan Hui ZOU, ShenZhen (CN)

Correspondence Address: JONES DAY, 29TH FLOOR, EDINBURGH TOWER, THE LANDMARK,, 15 QUEEN'S ROAD, CENTRAL, HONG KONG, CN

(73) Assignee: OKIA OPTICAL CO., LTD., Hong Kong (HK)

(21) Appl. No.: 12/853,323

(22) Filed: Aug. 10, 2010

Related U.S. Application Data
(62) Division of application No. 11/734,903, filed on Apr. 13, 2007.
(60) Provisional application No. 60/824,782, filed on Sep. 7, 2006.

(30) Foreign Application Priority Data
Apr. 30, 2006 (CN) 200620113601.4
Sep. 5, 2006 (IT) MI2006A001693
Sep. 11, 2006 (CN) 200620138916.4

(51) Int. Cl. B32B 38/00; B32B 38/14; B32B 38/16

(52) U.S. Cl. 156/221; 156/277

(57) ABSTRACT

A laminate with internal decorative pattern for eyeglass frames, formed by the application of heat and pressure comprising: a plurality of core layers of thermoplastic sheets printed with patterns by transfer printing; a first overlay layer of thermoplastic sheet; and a second overlay layer of thermoplastic sheet; wherein the core layers are sandwiched between the first overlay layer and the second overlay layer; the core layers may further enclose three dimensional articles or fluids for decorative or functional purposes. The process for manufacturing the laminate includes: preparing a plurality of core layers, a first overlay layer and a second overlay layer from thermoplastic sheets; printing patterns on the core layers by transfer printing; layering from top to bottom the first overlay layer, the core layers and second overlay layer; applying to the layer of sheets a temperature of 0° C. to 300° C. and a starting pressure of 0 atm to bond the layers together; and removing from the heat and pressure a laminate; wherein the process for manufacturing can further include steps of creating cavity in the core layers to enclose the three dimensional articles or fluids.

### RELATED APPLICATIONS

This is a divisional application of U.S. patent application Ser. No. 11/734,903, which claims the benefit of U.S. Provisional Patent Application Ser. No. 60/824,782, all of which are incorporated herein by reference. In addition, U.S. patent application Ser. No. 11/734,903 claims priority to Chinese Utility Model Application Serial Nos. 200620113601.4 filed Apr. 30, 2006 and 200620138916.4 filed Sep. 11, 2006, and Italian Patent Application MI2006A001693 filed Sep. 5, 2006, all of which are incorporated herein by reference.

### BACKGROUND OF THE INVENTION

The present invention relates generally to producing patterned laminates, in particular, to patterned laminates for eyeglass frames.

Eyeglass manufacturers have been making continuous effort in designing a great variety of eyeglass to satisfy consumers' needs and favorites. Eyeglass can alleviate eye defects such as myopia, hyperopia or astigmatism; or protect the eyes against bright daylight and ultraviolet light from the sun, hence become an essential product in daily life. Being worn on the face, it is often desirable that the design of eyeglass being aesthetic, gradually eyeglass also serves as a fashion accessory and even form part of the identity of some celebrities. The ornamentation of eyeglass is available in a wide range of styles, materials, premium designs, and further decorated with a selection of colors and patterns in the frames, including temples, eyeglass fronts, rims and bridges, to meet the preference of different consumers.

In conventional art, the decorative designs are two dimensional patterns or graphics. To produce eyeglass frames with decorative patterns, such patterns are usually transferred on the material surface, and further coated with a protective plastic layer. Because the protective layer can be worn out after prolonged use, ultimately the transferred patterns will also be depleted.

Accordingly, laminate material for eyeglass frame was developed and manufactured by the known method: A first plastic sheet is firstly pasted with a glue layer, which is then printed with desired patterns by silk screen printing. The intermediate laminate is pasted with another glue layer and glued to a second plastic sheet, and subsequently adhered together by hot compression. The resulting laminate has decorative patterns embedded between the two plastic sheets and is difficult to be worn out during use. However, the relevant configuration and manufacturing process of such laminate is complex, and has a lengthy production cycle. Further, a different silk screen is required if a different pattern is to be printed, resulting in low productivity and high manufacturing cost.

Cellulose Acetate is one of the most common thermoplastic materials applied on eyewear. It allows patterns to be transferred on thermoplastic sheets and overcomes the limitation for injection plastics.

In conventional technologies, eyeglass thermoplastic sheet has to be coated with a glue layer, and then printed with patterns by silk screen printing. When the ink dries up, another glue layer will be coated and adhere with a second plastic sheet by compression or thermal process. These techniques however are costly and time consuming, especially for producing polychrome patterns.

First of all, silk screen printing requires one mask for each monochrome and only one monochrome can be printed each time. In addition, to manufacture products with different patterns, a different set of silk screens is required. It also takes a long time to verify the silk screen pattern and the effect on sheet material, resulting in an extended production cycle. Furthermore, the pattern cannot be very fine because the ink is applied to the back of the image carrier and pushed through porous or open areas.

The conventional method is also limited to producing two dimensional patterns or graphics.

Thus, a need exists to improve the current manufacturing process for producing high density patterned cellulose acetate or thermoplastic laminate which is further embedded with materials like three dimensional articles or fluids.

### BRIEF DESCRIPTION OF THE INVENTION

A first aspect of the present disclosure, there is provided a laminate with internal decorative design for eyeglass frames. The laminate comprises: a plurality of core layers of thermoplastic sheets printed with patterns by transfer printing, a first overlay layer of thermoplastic sheet; a second overlay layer of thermoplastic sheet; wherein said core layers are sandwiched between said first overlay layer and said second overlay layer.

The core layers may further enclose particles or three dimensional articles. The three dimensional articles enclosed in core layers may be dry flowers, rhinestones, dry leaves or metal foil logo. The core layers may further enclose at least one kind of fluid, said fluids are immiscible with each other. The fluid enclosed in core layers may be colored or clear water, oil based fluid, or liquid silicone. The transfer printing may be heat pressing transfer, water transfer, vapor transfer, screen printing, or stencil printing. The thermoplastic may be cellulose acetate, cellulose acetate propionate, polycarbonate, TPE or nylon. The core layers and overlay layers may be adhered together by application of adhesive substance, application of heat, or application of pressure. The core layers and overlay layers may be bonded together by thermoform or lamination. The patterns printed on core layers may be monochromatic or polychromatic.

According to another aspect of the present invention, there is provided a process for manufacturing a laminate with internal decorative pattern for eyeglass frames. The process comprises the steps of: a) preparing a plurality of core layers, a first overlay layer and a second overlay layer from thermoplastic sheets, b) printing patterns on said core layers by transfer printing, c) layering from top to bottom said first overlay layer, said core layers and said second overlay layer, and d) bonding the layer of sheets from step (c).

The bonding step may be application of adhesive substance, application of heat, or application of pressure. The bonding step may be the step of thermoform or lamination. The bonding step may comprise the step of applying a temperature in the range of 0° C. to 300° C. and a pressure starting from 0 atm. The process may further comprise the step of laying particles on core layers before bonding said composite layer of sheets.

The process may further comprise the steps of: a) making cavities in said core layers before applying heat to said composite layer of sheets to enclose three dimensional articles or fluids, and b) positioning or filling said articles or fluids in said cavities. The thermoplastic may be cellulose acetate, cellulose acetate propionate, polycarbonate, TPE or nylon. The transfer printing may be heat pressing transfer, water transfer, vapor transfer, screen printing, or stencil printing. The heat pressing transfer may be a process of temperature in the range of 0° C. to 300° C. The three dimensional articles enclosed in core layers may be dry flowers, rhinestones, dry leaves or metal foil logo. The fluid enclosed in core layers may be colored or clear water, oil based fluid or liquid silicone. Other aspects of the invention are also disclosed.

### BRIEF DESCRIPTION OF THE DRAWINGS

One or more embodiments are now described with reference to the drawings, in which:

FIG. 1 shows the exploded view of a laminate embedded with planar pattern;

FIG. 2a shows the exploded view of a laminate embedded with three dimensional articles and fluids;

FIG. 2b shows the cross sectional view of a laminate embedded with three dimensional articles;

FIG. 3 shows the exploded view of a laminate embedded with particles;

FIG. 4 shows the perspective view of a laminate embedded with immiscible fluids;

FIG. 5 shows the perspective view of a laminate embedded with immiscible fluids and floating articles.

### DETAILED DESCRIPTION OF THE INVENTION

Where reference is made in any one or more of the accompanying drawings to steps and/or features, which have the same reference numerals, those steps and/or features have for the purposes of this description the same function(s) or operation(s), unless the contrary intention appears.

The preferred method described herein provides a laminate with internal pattern for eyeglass frames, such patterns and colors will not be affected by external conditions during use, and provide further advantages of simple configuration, low cost and short production cycle. The patterns can be in the form of two-dimensional art, particles, three dimensional articles, fluids, or a combination of the above.

In one embodiment, the laminate with internal pattern is assembled from a top layer, at least one middle layer or core layer, and a bottom layer. Adhered between the inner surface of the top and bottom layer is the core layer of thermoplastic sheets with decorative patterns printed by transfer printing. The top layer is a transparent thermoplastic sheet, whereas the middle and bottom layers can be transparent, semi-transparent, non-transparent thermoplastic sheet. The thermoplastic sheets can be made of common thermoplastic materials in the industry such as cellulose acetate, cellulose acetate propionate, polycarbonate, TPE or nylon.

The core layers described above are printed with patterns by transfer printing and adhered to the inner surface of the top layer or the inner surface of the bottom layer. The thermoplastic layers are bonded together by application of heat and pressure.

The method of transfer printing can be selected from common technologies in the industry including heat pressing transfer, water transfer, vapor transfer, screen printing, and stencil printing.

The layers can be adhered together by common method in the industry such as the use of adhesive substance, thermoform or lamination.

It is one of the advantages of the present invention that the printed patterns will not be affected by external conditions. Compared to conventional silk screen printing technology, the present invention provides a simple manufacturing process, short production cycle, and simple product configuration.

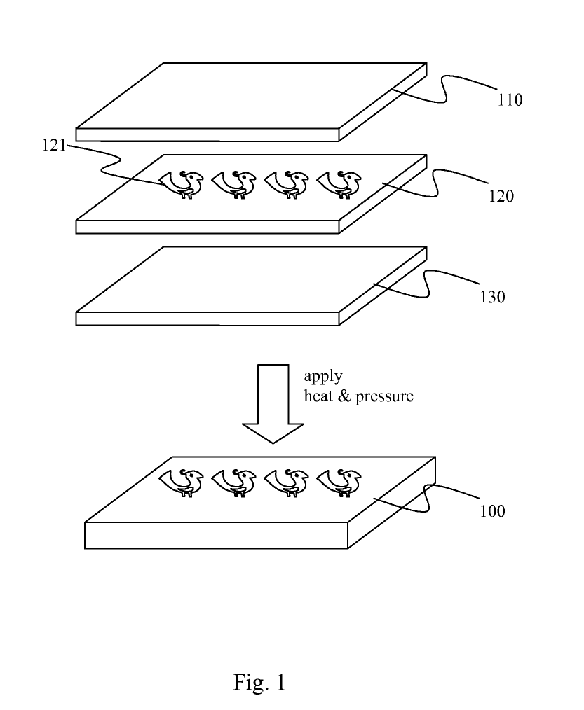

Disclosed in FIG. 1 is a laminate for eyeglass frames in accordance with an embodiment of the present disclosure. The laminate 100 comprises a top layer 110, a core layer 120, and a bottom layer 130. The bottom layer 130 is a thermoplastic sheet, the top layer 110 is a transparent thermoplastic sheet which can be chromatic or crystal clear. Adhered to the top layer 110 and bottom layer 130 is the core layer 120 printed with high density pattern 121 by transfer printing. The adhesion of the three layers can be accomplished by adhesive substances, such as UV glue or Acetone, thermoforming or any form of lamination. For complicated patterns or special pattern effects, more layers of pattered thermoplastic sheets can be adhered or sandwiched as a stack of thermoplastic between the top and bottom layers.

The thermoplastic used in the top layer 110, core layer 120 and bottom layer 130 is material that can re-soften and distort from its formed shape when heat above a critical temperature peculiar to the material. In the preferred embodiment of the disclosure, the thermoplastic material is cellulose acetate.

During transfer printing, a desired pattern with mirror image from a media is transferred to the core layer 120 by one of the following methods: heat pressing transfer, water transfer, vapor transfer, screen printing or any form of stencil printing. The media can be in the form of film, paper, fabric or any substance on which pattern is able to be printed. The heat pressing transfer involves a process in the temperature range from 0° C. to 300° C. The pattern being transferred to the core layer 120 can be monochrome or polychrome.

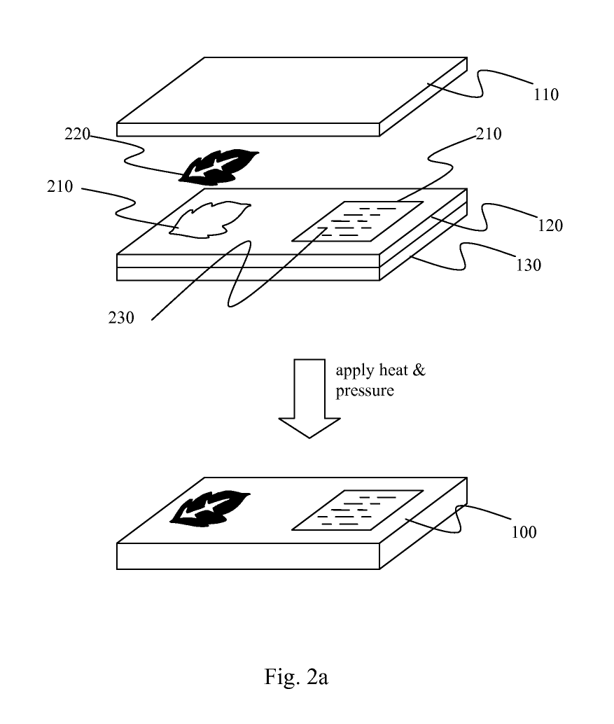

FIGS. 2a and 2b discloses a laminate according to the invention which has three dimensional articles or fluids embedded into the laminate, cavity 210 is created in the core layer 120 prior to adhering the top layer 110 to enclose the three dimensional articles 220 or fluids 230. The size and shape of the cavity 210 is created in a way to match the articles 220 or to contain the fluids 230. The process can be performed by drilling or grinding depending on the size and shape of the desired cavity. After the cavity 210 is created, the core layer 120 is adhered to the bottom layer 130. Articles are then positioned in the cavities of the core layer 120. In the case of fluid, it is filled in the cavities by injection apparatus or dropper.

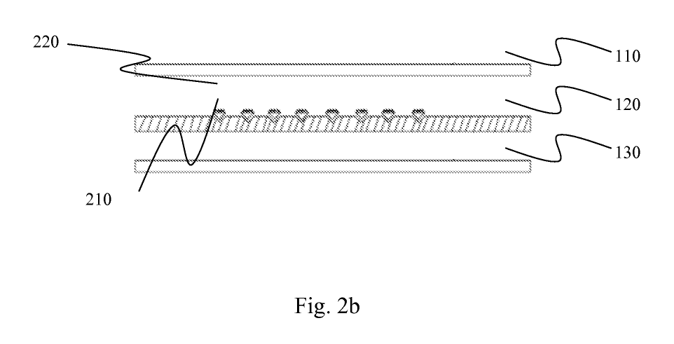

FIG. 3 further discloses a laminate according to the invention which has particles embedded into the laminate. Since the size of the particles 310 are small relative to the thickness of the thermoplastic layers, no cavity is required to be made in the core layer 120. The particles 310 are positioned on the core layer 120 to form the desired patterns.

After positioning the particles or three dimensional articles, or filling the fluids to the core layer 120, the top layer 110 is adhered to the core layer 120 as a coating to the patterns. The composite structure is then applied with temperature in the range of 0° C. to 300° C. and a pressure starting from 0 atm to bond the layers together and form a patterned laminate 100.

The articles or fluids embedded in the eyeglass frame can serve decorative or functional purpose. The three dimensional articles to be enclosed in the laminate can be selected from articles including dry flowers, rhinestones, dry leaves and metal foil logo. The fluids to be enclosed in the laminate can be selected from fluids including colored or clear water, oil based fluid, and liquid silicone.

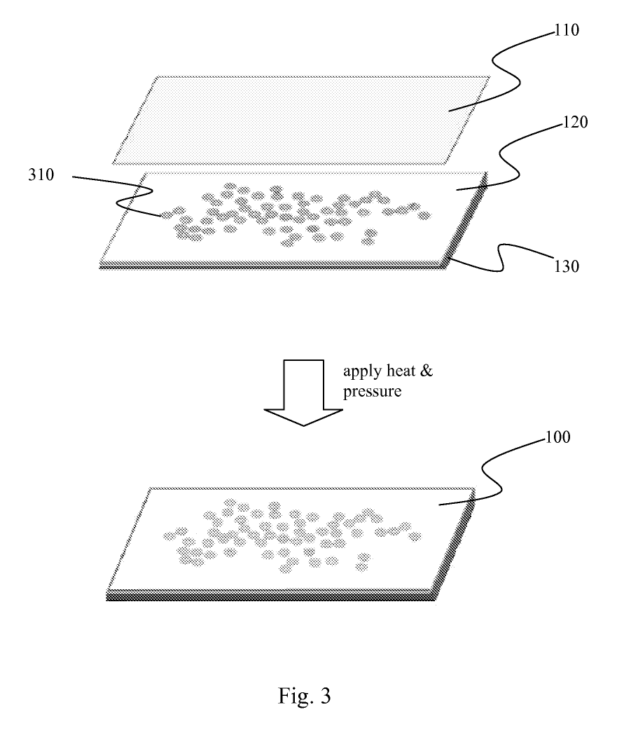

FIG. 4 describes a laminate in accordance with another embodiment of the invention, in which more than one type of immiscible fluid (410, 420) of different color can be embedded in the thermoplastic layers.

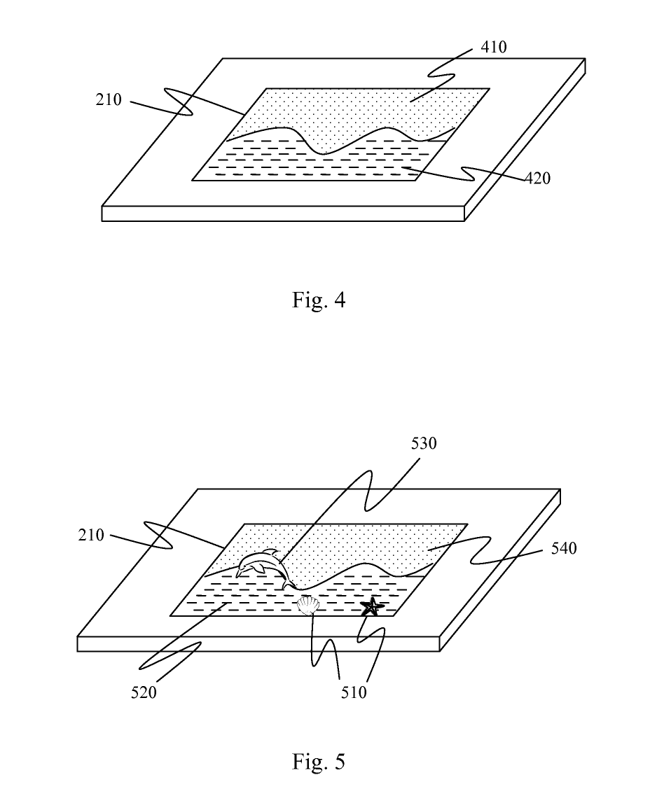

FIG. 5 describes a laminate in accordance with another embodiment, in which the cavity may further embed articles 510 which suspend in the fluid 520, or articles 530 which float on the surface of the fluid, or float at the boundary between two layers of fluids (520, 540).

The foregoing describes only some embodiments of the present invention, and modifications and/or changes can be made thereto without departing from the scope and spirit of the invention, the embodiments being illustrative and not restrictive.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A process for manufacturing an eyeglass frame comprising the step of forming the eyeglass frame from a laminate, wherein the laminate is manufactured by:
a) preparing a core layer or a plurality of core layers, a first overlay layer and a second overlay layer from thermoplastic sheets;
b) transferring patterns from a media having the mirror image of the patterns on the core layer or layers by transfer printing;
c) layering from top to bottom the first overlay layer, the core layer or layers and the second overlay layer to form a composite layer of sheets; and
d) bonding the composite layer of sheets to form a laminate.

2. The process according to claim 1, wherein the bonding step includes a step selected from the group consisting of: application of an adhesive substance, application of heat, and application of pressure.

3. The process according to claim 1, wherein the thermoplastic is selected from the group consisting of cellulose acetate, cellulose acetate propionate, polycarbonate, TPE, and nylon.

4. The process according to claim 1, wherein the transfer printing is heat pressing transfer or vapor transfer.

5. The process according to claim 1, further comprising laying particles on the core layer or layers before bonding the composite layer of sheets.

6. A process for manufacturing an eyeglass frame comprising the step of forming the eyeglass frame from a laminate, wherein the laminate is manufactured by:
a) preparing a core layer or a plurality of core layers and a first overlay layer from thermoplastic sheets;
b) transferring patterns from a media having the mirror image of the patterns on the core layer or layers by transfer printing;
c) layering from top to bottom the first overlay layer and the core layer or layers to form a composite layer of sheets; and
d) bonding the composite layer of sheets to form a laminate.

7. The process according to claim 6, wherein the bonding step includes a step selected from the group consisting of: application of an adhesive substance, application of heat, and application of pressure.

8. The process according to claim 6, wherein the thermoplastic is selected from the group consisting of cellulose acetate, cellulose acetate propionate, polycarbonate, TPE, and nylon.

9. The process according to claim 6, wherein the transfer printing is heat pressing transfer or vapor transfer.

10. The process according to claim 6, further comprising laying particles on the core layer or layers before bonding the composite layer of sheets.

11. A process for manufacturing an eyeglass frame comprising the step of forming the eyeglass frame from a laminate, wherein the laminate is manufactured by:
a) preparing a core layer or a plurality of core layers and a first overlay layer from thermoplastic sheets;
b) positioning particles or three dimensional articles on the core layer or layers;
c) layering from top to bottom the first overlay layer and the core layer or layers to form a composite layer of sheets;
d) bonding the composite layer of sheets; and
e) re-softening and distorting the core layer or plurality of core layers and the first overlay layer by heat.

12. The process according to claim 11, wherein the laminate further comprising a second overlay layer in the bottom.

13. The process according to claim 11, wherein the bonding step includes application of pressure.

14. The process according to claim 11, wherein the three dimensional articles are selected from the group consisting of dry flowers, rhinestones, dry leaves, and metal foil logo.

15. A process for manufacturing an eyeglass frame comprising the step of forming the eyeglass frame from a laminate, wherein the laminate is manufactured by:
a) preparing a core layer or a plurality of core layers and a first overlay layer from thermoplastic sheets;
b) transferring patterns from a media having the mirror image of the patterns on the core layer or layers by transfer printing;
c) layering from top to bottom the first overlay layer and the core layer or layers to form a composite layer of sheets;
d) bonding the composite layer of sheets; and
e) resoftening and distorting the core layer or plurality of core layers and the first overlay layer by heat.

16. The process according to claim 15, wherein the laminate further comprising a second overlay layer in the bottom.

17. The process according to claim 15, wherein the bonding step includes a step selected from the group consisting of: application of an adhesive substance, application of heat, and application of pressure.

18. The process according to claim 15, wherein the thermoplastic is selected from the group consisting of cellulose acetate, cellulose acetate propionate, polycarbonate, TPE, and nylon.

19. The process according to claim 15, wherein the transfer printing is heat pressing transfer or vapor transfer.

20. The process according to claim 15, further comprising laying particles on the core layer or layers before bonding the composite layer of sheets.
